(19) United States
(12) Patent Application Publication
(10) Pub. No.: US 2026/0067221 A1
(43) Pub. Date: Mar. 5, 2026

(54) SYSTEMS AND METHODS FOR PREDICTIVE CONGESTION MANAGEMENT USING APPLICATION SIGNALS

(71) Applicant: HUAWEI TECHNOLOGIES CO., LTD., SHENZHEN (CN)

(72) Inventors: Seyed Hossein MORTAZAVI, Kanata (CA); Mahmoud Mohamed BAHNASY, Kanata (CA); Hesam TAJBAKHSH, Kanata (CA); Ali MUNIR, Kanata (CA); Yashar GANJALI, Kanata (CA)

(73) Assignee: HUAWEI TECHNOLOGIES CO., LTD., SHENZHEN (CN)

(21) Appl. No.: 18/819,654

(22) Filed: Aug. 29, 2024

(51) Int. Cl. H04L 47/127; H04L 47/125; H04L 47/2466

(52) U.S. Cl. CPC H04L 47/127; H04L 47/125; H04L 47/2466

(57) ABSTRACT

Embodiments of the present application provide systems, apparatus and methods for predictive congestion management using signals from packet sources. According to a method, a network element predicts future traffic loads by receiving signals from multiple packet sources that indicate the size and timing of incoming data flows. By analysing these signals, the network element forecasts potential traffic surges. Before the predicted traffic arrives, the network element takes preventive actions to manage the data load. By addressing potential overloads in advance, the method may allow for smooth and efficient network operation, maintaining stability and preventing congestion.

### CROSS-REFERENCE TO RELATED APPLICATIONS

This is the first application filed for the present application.

### FIELD OF THE APPLICATION

The present application pertains to the field of network traffic management, and in particular to systems, methods and apparatus for managing and mitigating network congestion based on anticipated future traffic.

### BACKGROUND

Current congestion control mechanisms in communication network traffic management primarily rely on reactive strategies. These strategies depend on detecting explicit congestion signals, such as packet drops, or implicit signals, such as Explicit Congestion Notification (ECN), before initiating corrective actions to control data transmission rates. While this approach has been effective in traditional network settings, it has drawbacks when handling modern traffic patterns, which are often characterized by bursty or heterogeneous data flows. The inherent latency in responding to congestion after it occurs can lead to substantial performance degradation, with significant packet loss and network delays potentially transpiring before traditional congestion control mechanisms can react. This reactive approach is particularly detrimental to latency-sensitive applications, such as distributed machine learning and video streaming systems. Existing transport protocols attempt to estimate network state to adjust application transmission rates; however, this results in latency when responding to congestion, leading to issues such as queue buildup on switches and packet drops.

Therefore, there is a need for systems, apparatus and methods for managing and mitigating network congestion based on anticipated future traffic that obviates or mitigates one or more limitations of the prior art.

This background information is provided to reveal information believed by the applicant to be of possible relevance to the present application. No admission is necessarily intended, nor should be construed, that any of the preceding information constitutes prior art against the present application.

### SUMMARY

Embodiments of the present application provides systems, apparatus and methods for predictive congestion management (or predictive congestion notification (PCN)) using signals from packet sources, such as application signals. According to an aspect a method for managing network traffic passing through a network element is provided. The method is performed by the network element. The method includes receiving one or more signaling packets, each signaling packet comprising an indication that a packet flow of a given size is to be provided to the network element after a given time ΔT, processing the one or more signaling packets to determine a future traffic indicator which is generally increasing with a total number of the one or more signaling packets and prior to a beginning of the interval, performing one or more actions over a given time period (l), to mitigate a packet load at the network element during the interval.

In some embodiments, the one or more actions include ECN marking of packets during an advanced time interval (e.g., the given time period (l)) prior to the beginning of the interval. The ECN marking is performed to a degree that is generally increasing with the future traffic indicator The method may allow for ECN marking to be performed in advance of the future interval during which packet load is expected. The method may further allow for a variable degree of ECN marking based on the future traffic indicator.

In some embodiments, the ECN marking is performed to a degree that is greater than a baseline degree that is implemented for a baseline interval. The baseline interval is an interval other than the plurality of future time intervals and for which no signaling packets, indicating that packet flow to the network element, have been received. In some embodiments, the one or more actions include configuring, based on the future traffic indicator, ECN marking rules (e.g. lowering ECN marking threshold) to be applied by the network element during an advanced time interval prior to the beginning of the interval. In some embodiments, the network element is a switch or a router, or a similar device. In some embodiments, the network element is portion of a switch or router, or similar device, corresponding to a particular port or group of ports of the switch or router or similar device. In some embodiments, the signaling packets are dedicated to carrying the indications.

In some embodiments, the method further includes forwarding the packets toward a further network element. In some embodiments, at least one of the signaling packets includes a field specifying the interval or specifying a greater time interval which spans multiple successive ones of the plurality of future time intervals, including the interval. In some embodiments, the field at least in part provides the indications. In some embodiments, at least one of the signaling packets includes a field specifying a volume, rate or other indication of traffic level, and the future traffic indicator reflects a sum, over the one or more signaling packets, of the specified volumes, rates, or other indications of traffic level indicated therein. In some embodiments, the future traffic indicator is or comprises a count of the one or more signaling packets.

In some embodiments, the one or more actions are configured to generally increase in intensity with the future traffic indicator to facilitate the mitigation by affecting sources of the network traffic. The increase may be such that the sources of the network traffic reduce traffic output by a degree which increases with such increase in intensity. The method may provide for various degree of mitigation based on the intensity of the future traffic indicator. In some embodiments, the one or more actions include mitigating one or more packet flows based at least in part on packet flow priority. The method may allow for considering flow priorities in managing traffic flow.

In some embodiments, the one or more actions are performed during an advanced time interval that is configured to result in mitigating of the packet load at the network element during the time interval.

In some embodiments, the method further includes by at least one source of the one or more sources of packets, in advance of an anticipated increase in packet flow from the at least one source toward the network element, generating and transmitting at least one of the one or more signaling packets.

According to another aspect, a system comprising a network element and one or more packet sources is provided. The network element comprises processing electronics and a communication interface. The system configured, in support of managing network traffic passing through the network element, to perform one or more methods described herein.

According to another aspect, a (e.g. non-transitory) computer readable medium, computer program, or computer program product, comprising stored thereon statements and instructions which, when executed by a computer processor of a network element, or a combination of the network element and one or more of the sources, cause the network element, or the combination of the network element and the one or more of the sources, to perform one or more methods described herein.

According to another aspect, an apparatus or system is provided, where the apparatus includes modules configured to perform one or more methods described herein. According to another aspect, another apparatus or system is provided that includes computing electronics and is configured to perform the methods described herein. According to another aspect, another apparatus is provided that includes processing and wireless communication electronics and is configured to operate as described herein. According to another aspect, a system is provided that includes one or more apparatuses as described herein.

According to another aspect, an apparatus is provided, where the apparatus includes a memory, configured to store a program. The apparatus further includes a processor, configured to execute the program stored in the memory, and when the program stored in the memory is executed, the processor is configured to perform the methods in the different aspects described herein.

According to another aspect, a method is provided for execution by processing and wireless communication electronics. The method includes performing operations as described herein. In some embodiments a computer program product is provided. The computer program product includes a non-transitory computer readable medium having recorded thereon statements and instructions which, when executed by a computer, cause the computer to perform one or more methods described herein.

According to another aspect, a chip is provided, where the chip includes a processor and a data interface, and the processor reads, by using the data interface, an instruction stored in a memory, to perform the different aspects described herein.

Other aspects of the application provide for apparatus, and systems configured to implement the methods according to the different aspects disclosed herein. For example, wireless stations and access points can be configured with machine readable memory containing instructions, which when executed by the processors of these devices, configures the device to perform the methods disclosed herein.

Embodiments have been described above in conjunction with aspects of the present application upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present application will become apparent from the following detailed description, taken in combination with the appended drawings, in which:

FIG. 1A illustrates a system for PCN, according to an embodiment.

FIG. 1B illustrates the system of FIG. 1A at a later time interval, according to an embodiment.

FIG. 2 illustrates a packet header format for a signaling packet, according to an embodiment.

FIG. 3 illustrates a flowchart for updating a wheel of time (WoT) and triggering a mitigation action, according to an embodiment.

FIG. 4 illustrates a WoT clearing process, according to an embodiment.

FIG. 5A illustrates a system setup, according to an embodiment.

FIG. 5B illustrates results of the system setup of FIG. 5A, according to an embodiment.

FIG. 5C illustrates a system setup and network topology according to another embodiment.

FIG. 6 is a schematic diagram of an electronic device that may perform any or all of operations of the above methods and features explicitly or implicitly described herein, according to different embodiments of the present application.

FIG. 7 illustrates a method for managing traffic at a network element, according to an embodiment.

FIG. 8 illustrates another method for managing traffic at a network element, according to an embodiment.

It will be noted that throughout the appended drawings, like features are identified by like reference numerals.

### DETAILED DESCRIPTION

Embodiments of the present application provide systems, apparatus and methods for predictive congestion management using signals from packet source, such as application signals. Application signal may refer to an indication of an application's intent to send data. In some embodiments, a packet source running an application may send an indication of intent to send data via a signaling packet or tag as described herein. According to various embodiments, a network element may predict future traffic loads by receiving signals from multiple packet sources that indicate the size and timing of incoming data flows. By identifying and processing these signals, the network element may forecast future traffic conditions. Before the predicted traffic arrives, the network element may take preventive actions to manage the data load. By addressing potential overloads in advance, the method may allow for smooth and efficient network operation, maintaining stability and preventing congestion.

Current congestion control mechanisms in network traffic management generally rely on reactive congestion control mechanisms. As used herein, “network traffic” refers to transmissions such as packets which are generated and transmitted by a source toward a destination, and which pass through one or more network elements. Network elements can be routers, switches, or other communication devices which may receive and forward the packets. A network element can be a portion of a router or a switch. For example, a network element can refer to a functional portion of a router or switch which includes one or more input ports, output ports, or a combination thereof. The network traffic may be generated by applications running on the sources, and the sources of packets may be networked computers, mobile user equipment, or similar electronic devices. These mechanisms depend on detecting explicit congestion signals (such as packet drops) or implicit signals (such as ECN) before taking corrective actions to control packet transmissions. For example, when a source of packets detects a packet loss or ECN, it will generally reduce its rate of packet transmissions. Further examples of this behavior are found in various window size based flow control schemes as specified in various of the Transmission Control Protocol (TCP). While effective in traditional networks settings, this approach may have drawbacks when dealing with modern traffic patterns, especially those characterized by bursty or heterogeneous data flows. The inherent latency of responding to congestion after it occurs can lead to substantial performance degradation. Packet loss and network delays may have already transpired before a traditional congestion control mechanism can react. This reactive approach is particularly detrimental for latency-sensitive applications such as Distributed Machine Learning (DML) applications or video streaming systems.

The incorporation of predictive signals into traffic management represents a paradigm shift towards proactive congestion control. Predictive signals may leverage various network parameters such as queue lengths, buffer occupancy levels, or end-to-end round-trip time (RTT) to anticipate incipient congestion before it materializes. This perceptive knowledge may empower network elements to take preventive actions, such as throttling traffic flows. By proactively mitigating congestion rather than reacting to it after the fact, predictive signal-based congestion control mechanisms can improve network performance, particularly in scenarios with bursty traffic patterns. Furthermore, to facilitate such predictive approaches, according to embodiments, sources of packets (end-hosts) inform other devices (network elements) of anticipated future traffic flows.

The implementation of a congestion control module on a network element (e.g., a router or a switch, or portion thereof e.g. corresponding to a particular port of the router or switch) that aggregates signals from various end-hosts and triggers the activation of ECN on selective ports presents a promising avenue for proactive congestion control. According to an embodiment, this module can function as a centralized local decision-making entity, analyzing the aggregation of signals from end-hosts to forecast potential congestion events.

ECN, a congestion control mechanism embedded within, for example, the Data Center Transmission Control Protocol (DCTCP) protocol, uses an implicit notification mechanism that alerts senders to incoming congestion without resorting to packet drops. According to an embodiment, by proactively employing ECN prior to the onset of congestion conditions, the congestion control module may effectively throttle traffic flows on the most congested or congestion-prone ports, thereby alleviating network congestion and optimizing overall network performance.

Accordingly, the adoption of predictive signals and a congestion control module on one or more network elements may pave the way for a more proactive and efficacious approach to traffic management that circumvents the shortcoming inherent in reactive congestion control mechanisms.

In modern data centers, efficient network traffic management is important for optimal application performance and resource optimization. One prevalent approach to achieving this is through congestion control protocols such as DCTCP. In DCTCP, when congestion occurs, a switch participating in the data path explicitly notifies the sender by setting the Congestion Experienced (CE) code point in outgoing packets via ECN. Upon receiving a packet marked with CE, the DCTCP source interprets this as an indication of congestion along the path and reduces its congestion window by a factor relative to the fraction of marked packets received. While DCTCP plays a role, it suffers from limitations due to its reactive nature and relatively slow response time to network congestion. ECN generally relies on observing the queue size to infer congestion. However, queue size can be a lagging indicator of congestion, especially in bursty traffic conditions. By the time the queue builds up enough to trigger ECN marking, congestion might already be severe, or it may be too late to avoid a significant congestion event.

Some approaches propose automatic ECN tuning for high-speed data center networks. Traditional methods for setting the ECN threshold involve manually configuring each switch, which can be time-consuming and error-prone. One proposed solution, referred to as Automatic ECN Tuning for High-Speed Datacenter or ACC, leverages multi-agent reinforcement learning to dynamically adjust the ECN threshold. Each switch acts as an independent agent that observes the network state and takes actions to optimize its own performance. The agents are trained using offline data collected from various traffic patterns and then fine-tuned online to adapt to real-time network conditions. Another method, called Dynamic ECN marking threshold (DEMT), adjusts the ECN marking threshold based on the number of concurrent flows. A fixed threshold can lead to high queuing delay or low link utilization, so DEMT dynamically adjusts the threshold to find a balance between these two factors.

However, ACC and DEMT share the same shortcoming as DCTCP, as they react to congestion after it occurs by adjusting the ECN threshold. This makes them unsuitable for bursty traffic where rapid changes can make it difficult for ACC to adjust the ECN threshold quickly enough to prevent congestion during peak periods.

Another approach based on proactive congestion avoidance for distributed deep learning aims to mitigate distributed deep learning bottlenecks by adjusting ECN congestion marking thresholds on network switches proactively. This is done explicitly by the application to regulate the queue length within a switch before burst traffic arrives, resulting in the activation of ECN signals proactively. However, this approach is not well-suited for cloud computing environments where multiple users share a single network infrastructure. A switch port can only be configured with a single threshold, which can cause issues when multiple applications are competing for network resources. Furthermore, in cloud environments, network switch management is typically the responsibility of the cloud service provider, making the assumption of direct application control less feasible.

Existing transport protocols rely on estimating network state to adjust the application transmission rate. However, this approach may result in latency when responding to congestion after it occurs. This may further lead to substantial performance degradation, such as queue buildup on switches and packet drops.

According to embodiments of the present disclosure, Predictive Congestion Notification (PCN) is provided. According to another embodiment, a method is provided that aggregates application transmission information at the switches to provide an early congestion signal (e.g., PCN).

In one embodiment, PCN leverages the concept that the time between an application determining to transmit data and the actual transmission process could be aggregated at a network element and used to notify other network elements about future flow arrivals. For many applications, this time (ΔT) may include tasks such as data preparation (like serialization), header addition, checksum calculation, and other processing required to initiate data transmission. Message size information is typically available in most message-based communication Application Programming Interfaces (APIs), such as Remote Procedure Call (RPC), libverbs for Remote Direct Memory Access (RDMA), and collective communication APIs for DML.

In some embodiments, in PCN, one or more applications send a signaling packet (which may be referred to as a Tag) to one or more network elements. A signaling packet refers herein to a specialized packet for this purpose. A signaling packet can be a regular data (or control) packet with a particular configuration. The signal (signaling packet) contains information about the time of the next burst of transmission (e.g. ΔT seconds from now) and potentially other parameters (e.g., message size, or duration of transmission . . . etc.). Some or all of the other parameters may be optional parameters.

In certain embodiments of PCN, one or more sources of packets (e.g., one or more applications, or end devices hosting such applications) send one or more signaling packets (each may be referred to as a Tag) to one or more network elements. In some embodiments, each signaling packet includes information about the time of the next burst of transmission (ΔT) seconds from a current time) and may also include other parameters, such as message size or transmission duration. In some embodiments, each signaling packet includes an indication that a packet flow of a given size is to be transmitted toward the network element from one of the sources after a given time ΔT so that the packet flow is indicated to arrive during a future interval.

For further clarity, if the tag is transmitted from the source at time T₀, the packet flow is anticipated to be transmitted from the source at time T₀+ΔT. Assuming the flight time from source to network element is relatively constant, the burst will also arrive at the network element approximately ΔT seconds after arrival of the tag.

In some embodiments, a network element that receives the signaling packets (e.g. multiple tags from multiple sources) identifies and processes the one or more signaling packets to determine a future traffic indicator which is generally increasing with a total number of the one or more signaling packets. A “generally increasing” function refers for example to a mathematical function that is nondecreasing, i.e. in which the dependent variable stays the same or increases as the independent variable increases. The generally increasing function can be referred to in the alternative as a nondecreasing function. The generally increasing function may be a strictly increasing function in some embodiments. The more tags that are received indicating future traffic at a given time, the higher the anticipated volume of future traffic will be. For example, a first tag received at time T₁ can indicate a burst should be expected at time ΔT₁. A second tag received at time T₂ can indicate a burst should be expected at time ΔT₂. If T₁+ΔT₁ is approximately equal to T₂+ΔT₂, then the network element can determine that the two bursts will be experienced at the same or overlapping times, thus increasing potential future congestion. (Note T₁ may be equal to or different from T₂ and ΔT₁ may be equal to or different from ΔT₂.) When potential future congestion is sufficiently high, proactive mitigation actions can be taken.

In some embodiments, identifying and processing one or more signaling packets may involve the network element aggregating flow demands from the one or more sources of traffic over a control interval T and placing the signals (or indications derived from the signals) in an internal memory location or a time slot specified or indicated by the ΔT seconds in future. The sources of traffic can also be referred to as applications, end hosts or packet sources.

In some embodiments, the network element foresees network state at one or more future intervals by reading wheel-of-time (WoT) values corresponding to certain future time. The future time may be a certain interval into the future, the interval being specified by a look ahead time (referred to as LookAheadTime) or a LookAhead index. The LookAheadTime may be used to determine a LookAhead index based on the WoT. A packet source (e.g., an application) can send multiple signaling packets (e.g., tags) to a network element, and the network element may update multiple WoT indices, for example with each update being respectively based on a different one of the signaling packets. This may allow the network element to manage (e.g., throttle or suppress) the network traffic (e.g., background traffic) for a longer period of time. The WoT approach represents one implementation, involving a circular buffer or memory to track anticipated conditions for a limited number of future time intervals. However, more generally, the network element tracks indications of future traffic at one or multiple future times. Multiple indications of future traffic pertaining to the same future time are aggregated (e.g. added) together. Then, based on the indications of future traffic and prior to their occurrence at the future time, appropriate (e.g. proportional) mitigations actions are taken to avoid or reduce congestion at the future time.

In some embodiments, the network element performs actions to mitigate packet load at a future interval, based on its prediction of the network state for that interval. Given enough time for network traffic to react before the future interval begins, the network element takes actions over a time period (l) to reduce packet load during the future interval. In some embodiments, the time period, l, may refer to or represent L number of time slots or time intervals.

In one embodiment, the network element can trigger a mitigation signal (e.g., ECN marking, rerouting) using a future traffic indicator determined for a future time interval or a future time slot index on a specific output port for an adjustable constant (L) number of time slots or time intervals. The future time slot index may be equal to a current index plus a LookAhead index, where the current index represents current time and the LookAhead index may be a fixed or a variable value determined based on a LookAheadTime, as described elsewhere herein. This mitigation signal may allow sources of traffic to adjust their rates in response to ECN signals before congestion actually occurs.

In some embodiments, PCN is scalable due to the distributed aggregation mechanism at network elements. PCN is a proactive approach, as it anticipates traffic through signaling packets (Tags).

In some embodiments, PCN is based on proactively sending congestion notifications (e.g. ECN markings) from a network element to the sources of traffic by aggregating different signals (signaling packets) from packet sources received by the network element. In some embodiments, a method is provided that aggregates signals from packet sources calculated on network elements along the data path to predict congestion at the network elements (e.g., on the switch ports). Various embodiments may prevent or mitigate congestion from occurring at least at the network element implementing the embodiment.

Various appropriate mitigation actions may be performed, as may be appreciated, including one or more of: triggering ECN marking, selecting a different datapath, triggering topology reconfiguration, adding or tearing down a light/data path(s), and rerouting traffic. Essentially, a network element attempts to relieve upcoming congestion by causing a source to reduce the volume of traffic to that network element. The source can do this in a variety of ways, e.g. by reducing its transmission rate (or TCP window size), or by rerouting its packets, or, if feasible, by delaying transmissions. The ECN may prompt the source to take such an action without necessarily specifying the action to be taken. In some cases, an Optical Circuit Switch (OCS) may require some time (e.g., a few microseconds) to establish or tear down a light path. This process may require pre-configuration before actual data transmission begins. In some embodiments, by setting the LookAheadTime slightly larger or longer than the light path establishment time, a switch (e.g., OCS) can read from the WoT the expected flow arrival (e.g., in number) and prepare enough light paths to the required destination accordingly. For example, if the WoT indicates or detects (e.g., via reading the WoT value(s)) that an x number of flows will arrive after t time, and the current connection between a subject switch and an upstream switch is not enough or insufficient to handle such traffic, and where t is longer than the light-path-establishment time, embodiments may provide for triggering, by informing, the OCS that connects the subject switch to the upstream switch to establish another light path to accommodate the expected traffic. Some embodiments may inform the OCS switches to not tear down a light path connection even when traffic is slowing down if it is determined or detected, via reading the WoT value(s), that traffic is expected or forecasted to increase in the future.

In one embodiment, a WoT is designed to measure future network events by aggregating application information at a network element. The WoT may be implemented within the data plane of network elements. It can be used to perform Network-Application Integration (NAI) detection at the network elements. Network elements such as switches, controllers, or hosts can perform appropriate mitigation actions or operations. Various appropriate mitigation actions may be performed, as may be appreciated, including one or more of: triggering ECN marking, selecting different data paths, triggering topology reconfiguration, adding or tearing down light path(s) or data path(s), and rerouting traffic.

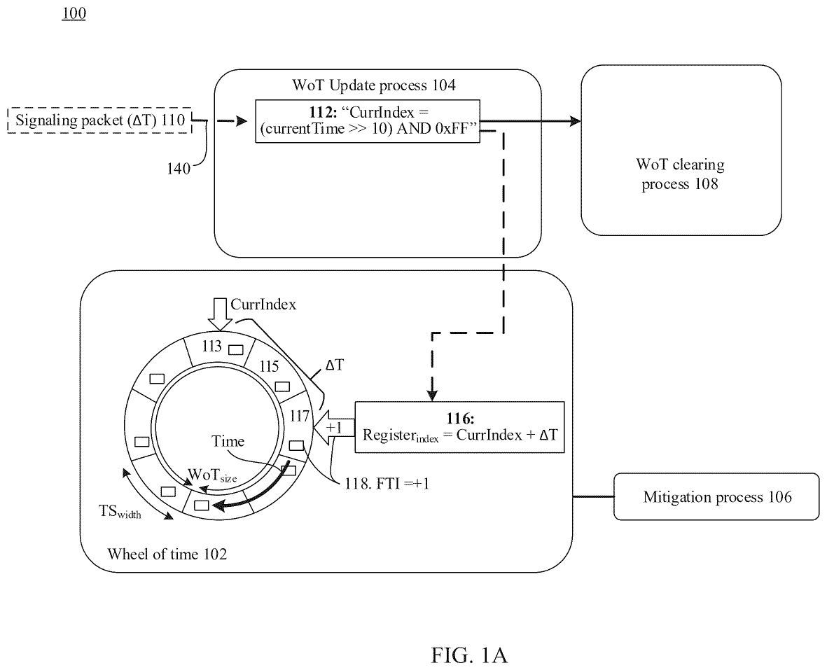

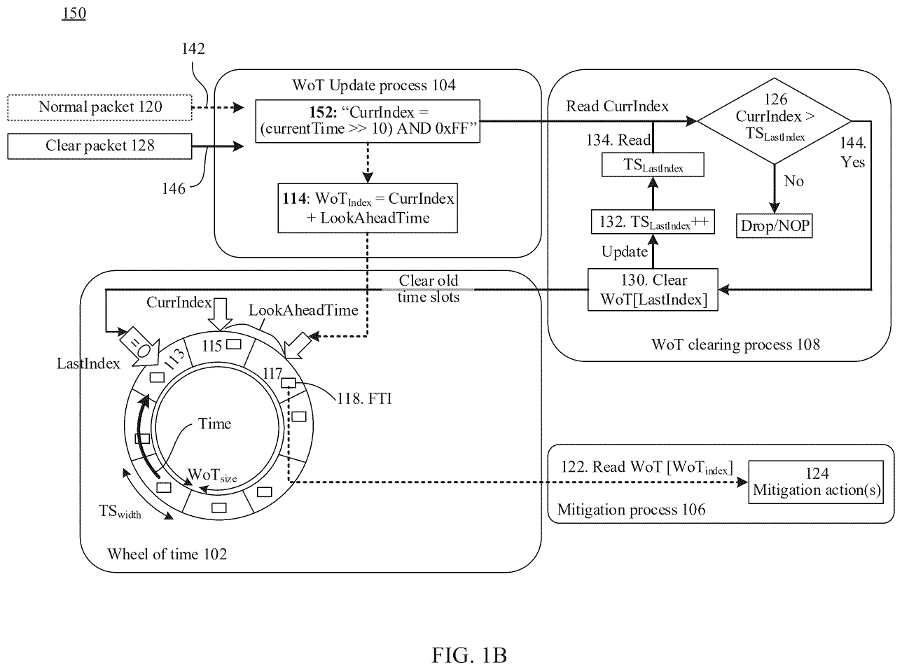

FIG. 1A illustrates a system for PCN, according to an embodiment. In an embodiment, the system 100 includes one or more of: a WoT module or WoT 102, a WoT update process 104, a mitigation process 106, and a WoT clearing process 108. In some embodiments, the system 100 is implemented at a network element. In some embodiments, the system 100 is implemented at the data path level, obviating the need for table lookups. In some embodiments, the system 100 is implemented at each one or more ports of the network element.

In some embodiments, the WoT module 102 is a register or a circular array data structure that divides time into discrete time slots. For example, a WoT may be implemented using an array of 2048 entries, with each entry representing a 128 μs time slot. Each WoT index (or register index) may represent an interval and have a corresponding traffic indicator. A current index (CurrIndex) determined based on a current time is the reference point for determining a future interval and a corresponding future traffic indicator. For example, in FIG. 1A, the CurrIndex is interval 113 and intervals 115 and 117 are future intervals, each having a corresponding future traffic indicator, where future interval 117 has a future traffic indicator 118. In some embodiments, where appropriate, performing operations on the WoT may refer to performing operations on or relating to the traffic indicator(s) (or future traffic indicator(s)) of the WoT. For example, reading values of the WoT may refer to reading corresponding traffic indicator(s) (or future traffic indicator(s) where appropriate). Similarly, updating the WoT or updating the WoT values may refer to updating (e.g., incrementing, clearing, etc.) traffic indicator(s) (or future traffic indicator(s) where appropriate) of the WoT.

According to an embodiment, a packet source (e.g., an application) sends a signaling packet 110 (e.g. a tag packet or a tag) to a network element. In some embodiments, the signaling packet 110 indicates a packet flow of a given size to be provided to the network element after a given time ΔT, which may be referred to as a lead time. Lead time may refer to the time interval between the time of arrival of the signaling packet and the arrival of the packet flow. For example, an application may send a signaling packet 110 to indicate that future traffic transmission will start ΔT seconds after the signaling packet is sent. The lead time, ΔT, may be used to notify network elements about the impending or future state change. In some embodiments, the WoT module 102 continuously monitors for incoming signaling packets and processes them to determine a future traffic indicator, which generally increases with the total number of signaling packets received and which specify a same future time (determined by signaling packet arrival time plus lead time). The future traffic indicator for a particular time (and port, if applicable) can be, for example, a counter indicating the number of signaling packets specifying that particular time (and port, if applicable). In some embodiments, the network element, via the WoT module 102, aggregates information from all flows passing through the same egress ports to determine a future network state (e.g., a level of traffic). As an example, a signaling packet can be sent using a User Datagram Protocol (UDP) channel on port number 8999 with the same destination IP as the original flow.

In some embodiments, the lead time ΔT is constant for all signaling packets. In this case, the lead time might not be explicitly specified in the signaling packet. Rather, a signaling packet may inherently indicate that a future packet flow is to be expected ΔT seconds after the signaling packet arrives. In some embodiments, the lead time is variable and can be specified to a particular level of granularity, which may be fixed or configurable.

According to an embodiment, when a signaling packet 110 is received at the network element, the network element may undergo a WoT update process 104, which involves calculating or determining 112 a current time slot 113 indicated by a time slot index (e.g., CurrIndex). Current time slot index may represent the position in the WoT array where the current time falls, e.g. the index of the WoT array which corresponds to the current time. In some embodiment this may involve performing a division and modulus operation, for example, CurrIndex=(CurrentTime/TS_{Width}) % WoT_{¿¿¿}, where CurrentTime refers to a time when the signaling packet is received, TS_{Width} is the width of time slot (or time interval) and represents the duration of each time slot in the WoT, and WoT_{¿¿¿} is the total number of slots in the WoT, indicating the size of the circular array. In some embodiment, e.g., in the hardware, a bitwise shift and AND operation may be performed 112 to avoid division (i.e., CurrIndex=\(CurrentTime»10\) AND 0xFF, where, for example, TS_{width}=2¹⁰ and WoT_{¿=0xFF+1=256 slots¿}).

In some embodiments, after obtaining the current time slot index, a future time slot or interval 117 in the WoT is determined 116 for updating a future traffic indicator 118 of the future time slot. This future time slot, indicated by a future time slot index or a register index, may be determined as follows: [symbol] g_{Index}=CurrIndex+ΔT. This future time slot corresponds to the position (index) of the WoT array which in turn corresponds to the current time plus the ΔT which may have been indicated in the signaling packet. Thereafter, a corresponding future traffic indicator 118 held in the WoT array at this future time slot 117 may be updated. For example, a counter is incremented to indicate a flow, as may be identified in the signaling packet 110, is arriving at the determined future time slot. In some embodiments, the future traffic indicator (e.g., counter) 118 for a future time slot or interval is updated proportional to the number of signaling packets received indicating transmission of packet flow at said future time slot. For example, the future traffic indicator 118 for a given time slot in the WoT array can be incremented each time a signaling packet is received that prompts updating of this same time slot in the manner outlined above.

In certain embodiments, for a future packet flow extending across multiple future time slots or time intervals, the source may transmit a corresponding signaling packet for each of these multiple future time slots. Each signaling packet may indicate the lead time, ΔT, for a respective future time slot of the multiple future time slots. In this case, multiple signaling packets may be used to indicate a future traffic flow which lasts for a corresponding multiple time slots. In some embodiments, a single signaling packet may convey both the lead time and the duration of the packet flow across multiple future time slots. In this case, a single signaling packet can prompt updating of multiple time slots in the WoT array. That is, counters (or other indicators) at each of a contiguous block of M time slots in the WoT array, beginning with the time slot at index indicated by CurrIndex+ΔT, can be incremented, where M is the specified duration of the packet flow, which may be expressed in time slots. In various embodiments, value M may be equal to value L, so that the duration (in time slots) of the flow is equal to the duration of the corresponding mitigation actions.

Accordingly, in some embodiments, if a future packet flow spans multiple future time slots or time intervals, the source may send a corresponding signaling packet for each of the multiple future time slots, each signaling packet indicating a lead time for the corresponding said future time slot. In some embodiments, one signaling packet may indicate a lead time and the duration of the packet flow across multiple future time slots.

In some embodiments, the system 100 may perform a mitigation process 106 as described in reference to FIG. 1B. FIG. 1B illustrates the system of FIG. 1A at a later time interval, according to an embodiment. System 150 may refer to system 100 at a later time, for example, at one time slot or interval later. In system 100, the CurrIndex is at time interval 113, whereas in system 150, the CurrIndex is at time interval 115 as illustrated.

In some embodiments, the mitigation process 106 involves receiving a normal packet 120, e.g., a data packet. In an embodiment, a packet source sends the normal packet 120 to the network element. The network element may receive the normal packet and determine 152 a current time slot index or a current register index (e.g., CurrIndex) indicative of the current time. In this case, the current register index will be the time slot or interval 115. Thereafter, a future time slot or interval 117, indicated by WoT_{Index}, may be determined 114 by the network element based on a LookAheadTime and the determined CurrIndex 152. In this case, the future time slot or interval 117 is the same as the time slot or interval 117 for which the future traffic indicator 118 was set as described in reference to FIG. 1A. Therefore, a mitigation action 124 will occur. In other cases, the future time slot or interval might be another interval for which no future traffic indicator is set, and in such cases a mitigation action might not occur.

The LookAheadTime may refer to a duration of time that is enough or adequate for the network traffic (e.g., the packet source that sent the normal packet 120 and/or other sources of packets) to react (e.g., perform one or more actions) before the beginning of the future time slot or interval 117 to mitigate a packet load during the future time slot or interval. In some embodiments, the future time slot or interval is determined 114 as follows: WoT_{Index}=CurrIndex+LookAheadTime. In some embodiments, the network element may then read 122 a future traffic indicator corresponding to the determined future time slot, WoT_{index}. The network element may then perform 124 one or more actions according to a mitigation process 106. The mitigation process may be performed (or not, as the case may be) based on the future traffic indicator 118 corresponding to the determined future time slot, which in this case is the time slot 117. In some embodiments, the LookAheadTime is greater than one round trip time (RTT) to cover the time needed for a packet to be sent to a destination, with an ECN included, plus the time for the destination to notify the packet source of the congestion, plus the time needed for a packet to reach the switch again after applying the reaction at the source. Additional time maybe required depending on the time needed for the source to react to the notification. In some embodiments, the LookAheadTime that is used by the network element to determine the relevant future time interval(s) is specific to the packet source and is based on the relevant period needed for the packet source to react to avoid or minimize the likelihood of a predicted traffic state (e.g., congestion) to occur at said relevant future time interval(s). For example, the LookAheadTime may be based, among other factors, on one or more of: data path distance from the source to destination, data path distance from the source to the network element, data path distance from the network element to the destination. Data path distance may be expressed as a time required to traverse the data path rather than a physical distance. In some embodiments, the network element uses the Time To Live (TTL) field to determine the LookAheadTime or a configurable table to specify the mapping between packet sources and LookAheadTime values. Thus, in some embodiments, the network element may use a first LookAheadTime for a first packet source to determine whether a mitigation action related to the first packet source is needed and use a second LookAheadTime (potentially different from the first LookAheadTime) for a second packet source to determine whether a mitigation action related to the second packet source is needed.

In some embodiments, the one or more mitigation actions 124 include ECN marking of packets which arrive during an advanced time interval (e.g., time interval 115) prior to the beginning of a future time interval or time slot (e.g., time interval 117), determined via the LookAheadTime. In this context “advanced time interval” refers to the time interval being prior to the beginning of the future time interval or time slot. In some embodiments, the ECN marking is performed to a degree that is generally increasing with the future traffic indicator corresponding to the future interval. In some embodiments, the ECN marking is performed to a degree that is greater than a baseline degree that is implemented for a baseline interval, the baseline interval being other than future time intervals for which no signaling packets, indicating that packet flow to the network element, have been received. That is, ECN markings are increased when there is a future traffic indicator, or at least a threshold amount of future traffic indicators. In some embodiments, the one or mitigation actions 124 include configuring, based on the future traffic indicator, ECN marking rules (e.g. lowering ECN marking threshold) to be applied by the network element during an advanced time interval 115 prior to the beginning of the future interval 117. In some embodiments, the one or mitigation actions 124 include mitigating one or more packet flows based at least in part on packet flow priority. In some embodiments, the one or mitigation actions 124 are performed during an advanced time interval 115 that is configured to result in mitigating of the packet load at the network element during the future time interval 117. In some embodiments the one or mitigation actions 124 are configured to generally increase in intensity with the future traffic indicator to facilitate the mitigation by affecting sources of the network traffic. Increasing intensity refers to the mitigation actions causing a greater amount of mitigation with greater intensity. For example, increasing intensity of ECNs can refer to more ECNs being sent to sources, for example such that ECNs are sent to more sources. Increasing intensity of ECNs can refer to parameters specified in ECNs causing a greater throttling of traffic at the sources to which the ECNs are sent. Regarding packet flow priority, different packets, of different packet flows, can have different priority levels. These levels can be used at the network element to prioritize the processing of packets for example according to a priority queuing approach, as will be readily understood by a worker skilled in the art. The packet flow priority can reflect the priority of an application which the packet flow supports, or the priority of a device from which the packet flow originates or terminates, or the like, or a combination thereof. Therefore, higher priority packet flows can be mitigated to a lesser extent than lower priority packet flows. For greater clarity, this mitigation can apply to some or all packets of the packet flows. Packet flow priorities, inherited from applications or devices, can be relative to one another, or they can be reflected as non-relative priority values.

Referring to FIG. 1B, in some embodiments, the network element may perform a WoT clearing process 108. In some embodiments, upon or after determining 152 a current time slot index, CurrIndex, the network element may determine 126 whether the CurrIndex is greater than a last calculated current index, TS_{LastIndex} (or LastIndex). If the CurrIndex is not greater than TS_{LastIndex}, then then the clearing process 108 ends and may restart again upon determining a next current time slot index.

In some embodiments, the network element determines 144 that the CurrIndex is greater than TS_{LastIndex}. For example, the CurrIndex in system 150 may indicate time interval 115 which has a higher corresponding index than the last calculated current index, being based on the time interval 113 of system 100 of FIG. 1A. Upon such determination, network element may generate a clear packet 128 for clearing outdated slots based on the last current index and the current index. The network element may then clear 130 the stored data (e.g., a future traffic indicator (counter value, etc.)) corresponding to the TS_{LastIndex}, indicated by WoT[lastIndex], which may refer to a past time slot or interval (e.g., time slot or interval 113). The last current index, TS_{LastIndex}, may then be updated (e.g., incremented 132 to move forward in time) to evaluate whether the updated TS_{LastIndex} satisfies the condition 126. The updated TS_{LastIndex} may be determined based on a time direction from the last current time slot (indicated by LastIndex) toward the current time slot (indicated by CurrIndex). The time direction may refer to the sequence in which time slots are processed within the WoT data structure. The network element may then read 134 the updated TS_{LastIndex} to evaluate the condition 126. Where the condition 126 is determined 144 true, the same operations, 130, 132, 134 and 126 may continue until the CurrIndex is not greater than an updated TS_{LastIndex}, at which point, the clear packet 128 is dropped.

In some embodiments, the network element tracks each CurrIndex determined e.g., 112, 152 and upon each determination, the network element clears the time slots between the CurrIndex and the TS_{LastIndex}, until CurrIndex equals the TS_{LastIndex}. As may be appreciated, the clearing of time slot is meant to remove any residual value that may be kept from a previous updating of the wheel of time, where the residual values are obsolete.

As illustrated, the one or more operations for updating the WoT based on the signaling packet 110 are indicated by dashed lines 140 in FIG. 1A. Further, the one or more operations involved in performing one or more mitigation actions based on a normal packet 120 are indicated by dotted lines 142 in FIG. 1B. In addition, one or more operations involved in the clearing process 108 are indicated by solid line 146.

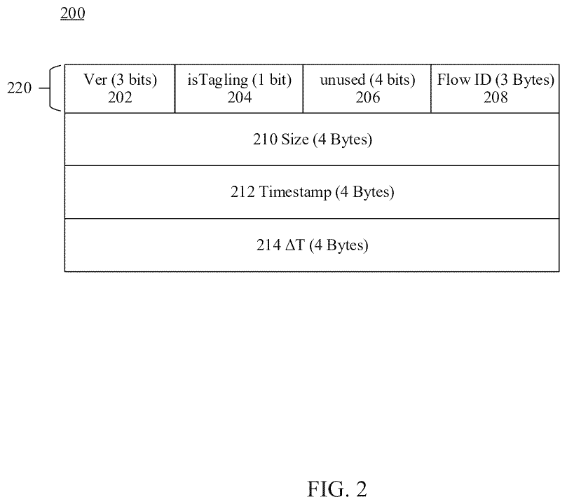

FIG. 2 illustrates a packet header format for a signaling packet, according to an embodiment. The header format 200 is an example header format for a signaling packet 110. A signaling packet may also be referred to as a tag packet or a tag. In some embodiments, the header 200 includes one or more fields indicating one or more of: a version (ver) 202, an isTagling flag 204, a flow identifier (ID) 208, a size 210, a timestamp 212, and a lead time, ΔT, 214. In some embodiments, the size indicator 210 may indicate one or more of a volume, rate or other indication of traffic level. In some embodiments, the size indicator 210 indicates a remaining size (e.g. expressed in number of packets or length of time) of a corresponding packet flow. In some embodiments, the size indicator 210 indicates an average flow size. In some embodiment, the size indicator 210 may be associated with the lead time field 214. For example, a traffic of a size, indicated by size indicator 210, is to arrive in ΔT time, indicated by lead time indicator 214, after a current time. In some embodiments, the lead time, ΔT, indicator 214 and the size indicator 210 may be used, e.g., by a network element, to determine one or more future intervals during which a packet flow of a size indicated by the size indicator 210 is expected to arrive. In some embodiments, the lead time, ΔT, indicator 214 indicates the first future interval, and the size indicator 210 indicates how long, e.g., number of timeslots or intervals from the first future interval, much the flow spans in the future. In some embodiments, the header 200 indicates a flow start time and flow size. In some embodiments, the header may include a field or flag indicating that it is a signaling packet.

In some embodiments, the signaling packet are generated and sent from a source of traffic, where the signaling packet indicates changes in the application state. In some embodiments, the signaling packet is generated by an NAI agent. In some embodiments, the flow ID 208 is a compound key that includes the NAI agent's ID and a local counter, where the NAI agent ID may be set by a network administrator or administration program.

In some embodiments, the signaling packet is dedicated packet for indicating that a packet flow of a given size(s) is to be provided to the network element from a source during a future interval determined after a given lead time, Δt, so that the packet flow is indicated to arrive during the interval. The size(s) can be expressed in number of packets, duration, volume of data, or the like. The size(s) can be explicitly specified in the signaling packet or inferred to be a certain default value, e.g. if unspecified. In some embodiments, the signaling packet includes a field (e.g., a field indicating a lead time 214) specifying one or more future intervals during which the packet flow is expected to arrive at the network element.

In some embodiments, the isTagling flag or indicator 204 may be used by a network element to associate a normal packet to a signaling packet. In some embodiments, the isTagling indicator 204 is used for determining prioritization for ECN threshold adjustment. In some embodiment, a high priority application traffic includes the isTagling indicator in the signaling packet header to indicate a priority level (e.g., indicate that the application traffic is high priority). In some embodiments, the network element may use the isTagling indicator to determine one or more traffic to include or exclude from ECN application. For example, the network element may exclude higher level priority traffic from ECN application. In some embodiments, if the isTagling indicator 204 is set (i.e., indicating a high priority traffic), the size indicator 210 and the lead time indicator 214 may be set to zero. However, in some embodiments, if a host (a traffic source) intends to send or inject more data to a current data flow, the host may use the size indicator 210 and the lead time, ΔT, indicator 214 to communicate when this additional data is expected to arrive.

As may be appreciated, the indicators Ver 202, isTagling 204, Flow ID 208, size 210, timestamp 212, and lead time 214 may be implemented in a signaling packet in various ways, and as such, the header format may vary. The illustrated format 200 and the allocated size for each indicator is only an example implementation. For example, the header format 200 includes a first field 220, which includes one or more subfields for indicating Ver 202, isTagling 204 and FlowID 208. In some embodiments, the first field 220 includes a portion 206 (e.g., 4 bits) that is unused or reserved. In some embodiments, the first field 220 includes a portion 206 (e.g., 4 bits) that is unused or reserved. As mentioned, the header format 200 is not limited to the illustrated format and can be configured in other ways as may be appreciated.

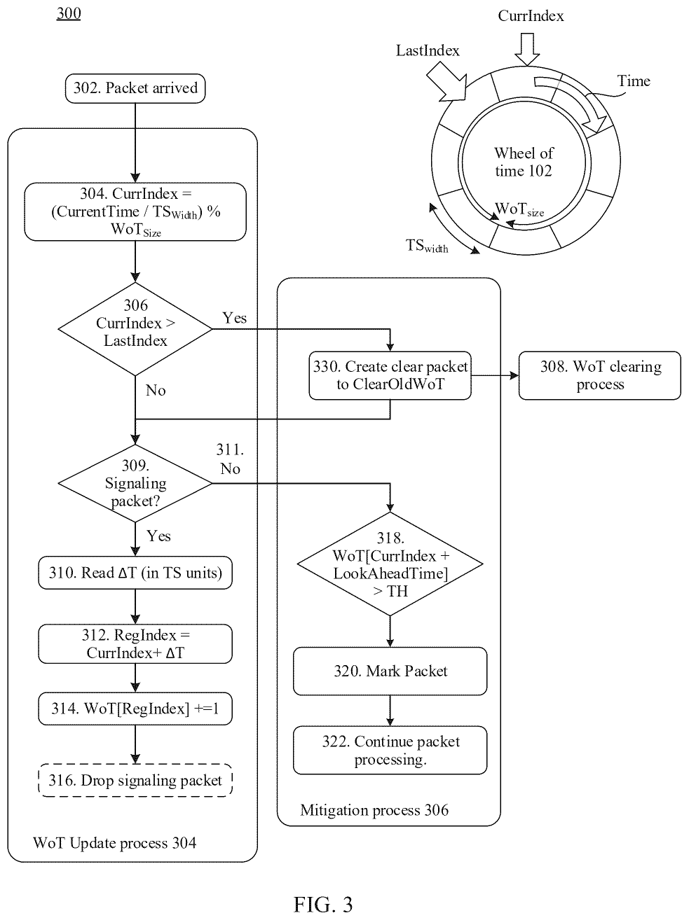

FIG. 3 illustrates a flowchart for updating the WoT and triggering a mitigation action, according to an embodiment. Flowchart 300 represents a working mechanism for PCN at a network element. In some embodiment, flowchart 300 may be implemented at the data path level, operating without using table lookups. Flowchart 300 includes a WoT update process 304, a mitigation process 306, and a WoT clearing process 308. In some embodiments, the WoT update process 304 may be similar to the WoT update process 104. Similarly, the mitigation process 306 and the WoT clearing process 308 may be similar to the corresponding mitigation process 106 and the WoT clearing process 108 as described herein.

Flowchart 300 illustrates how PCN operates, at a network element, based on the type of packet received. According to an embodiment, when a packet (e.g., a signaling packet or a normal packet) arrives 302 at the network element, the network element determines 304 a current index (CurrIndex) of the WoT 102, that correspond to a current time (CurrentTime) at which the packet arrives. The determination 304 of CurrIndex may be similar to the determination 112 of system 100. In some embodiments, determining 304 the CurrIndex involves translating or converting the current time to an index which is used to represent a current time slot index (CurrIndex) in the WoT. Such an index, TS_{Index}, may be determined or calculated as follows: CurrIndex=TS_{index}=(CurrentTime/TS_{Width}) % WoT_{¿¿¿}.

In some embodiments, the network element determines 309 whether the received packet is a signaling packet 110. Where the received packet is a signaling packet, network element may further determine a future time slot or interval in the WoT 102 for updating a future traffic indicator corresponding to that future time slot or interval. This may involve, the network element reading 310 the lead time, ΔT in TS units, indicated in (or implied by) the signaling packet. The network element then may obtain 312 the register index corresponding to the future time slot in the WoT based on the determined CurrIndex and the lead time, ΔT, as follows: [symbol] g_{Index}=CurrIndex+ΔT. In some embodiments, operations 312 may be similar to operations 116.

In some embodiments, the network element may then update 314 the WoT by, e.g., incrementing or adding 1 at the corresponding index (WoT[RegIndx]+=1 which is similar to updating the corresponding future traffic indicator). The updating 314 may be similar to the updating of the future traffic indicator 118 of FIG. 1A. In some embodiments, the network element drops 316 the signaling packet. Alternatively, the network element may forward the signaling packet onward to a next device. Other types of updates (instead of incrementing by 1) may also be performed, for example the entry at WoT[regIndx] can be increased by a certain value indicative of a traffic level in the signaling packet, based on a priority level indicated in the signaling packet, or the like, or a combination thereof.

In some embodiments, the network element determines 311 that the received packet is not a signaling packet. For example, the network element may determine that the received packet is a normal packet, e.g., a data packet. The network element may further determine 318 a future time slot or interval in the WoT, indicated by WoT_{Index}, based on the CurrIndex and a LookAheadTime parameters, where WoT_{Index}=WoT[CurrIndex+LookAheadTime]. In some embodiments, the network element may calculate the RegIndex inside the WoT to read the state of the network, the future traffic indicator, in the future after a LookAheadTime slots from now (e.g., Read←WoT[CurrIndx+LookAheadTime]). In some embodiments, the LookAheadTime is taken to be a sufficient time (e.g., equal to or at least equal to the time) required for a TCP protocol being employed to react to a network state. For example, the network state may be a network bottleneck, such as a congestion, where the LookAheadTime may two round-trip times (RTTs). The RTT may be the time interval between a source transmitting a packet and the source receiving an acknowledgement of the packet from its destination (where the acknowledgement may include an ECN). In some embodiments, a threshold may be set for the network state, and the network element may determine 318 whether the future network state, e.g., the future traffic indicator corresponding to the WoT_{Index}, exceeds the threshold for performing one or more actions. The LookAheadTime is configured so that, when the packet is marked and subsequently the source reacts to the packet marking by reducing its transmissions (e.g. due to reducing its TCP window size), the results of such reduction are seen at the network element at a future time corresponding to the LookAheadTime. When this future time is also a time of anticipated congestion as indicated by prior signaling packets and as stored in the WoT, a mitigation action may be initiated.

In some embodiments, where the future network state, e.g., future traffic indicator, does not exceed the threshold, the network element may process the received packet normally. In some embodiments, where the future network state, e.g., future traffic indicator, exceeds the threshold, the network element may perform one or more mitigation actions. For example, the network element may mark 320 the received packet using ECN marking. The network element may then continue 322 packet processing. In some embodiments, rather than or in addition to a threshold, the mitigation action may generally increase with the contents of WoT[CurrIndx+LookAheadTime]. For example, the probability of marking a packet with an ECN marking may increase with such contents, or the ECN may include an indication of severity which increases with such contents.

In some embodiments, when the CurrIndex is determined 304, the network element determines 306 whether the CurrIndex is greater than a previously or last determined current index, TS_{LastIndex} or LastIndex. In some embodiments, the one or more operations 306 may be similar to the one or more operations 126. Where the network element determines that the CurrIndex is not greater than the LastIndex, then the network element continues performing operations 309. When the network element determines that the CurrIndex is greater than the LastIndex, then the network element generates or creates 330 a clear packet to clear outdated slots, ClearOldWoT. The network element may then perform a WoT clearing process 308, which may be similar to the WoT clearing process 108.

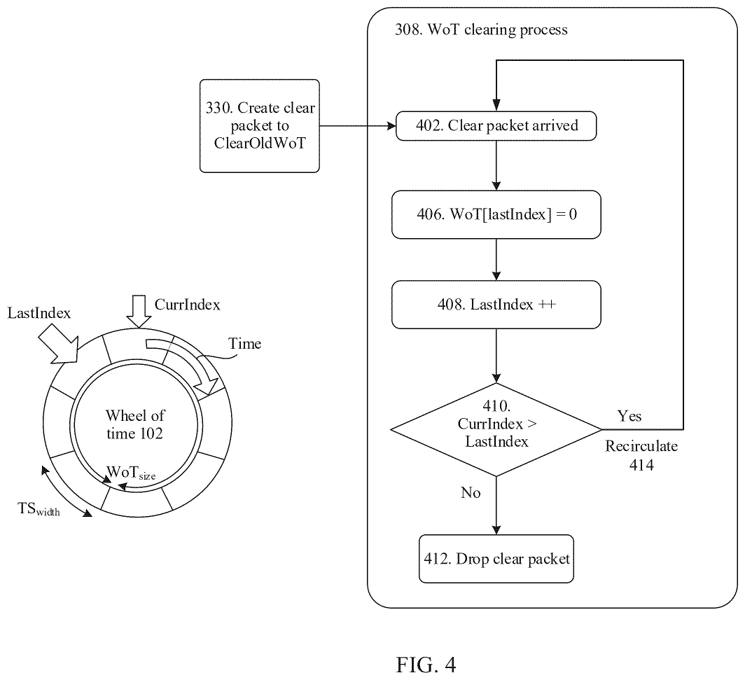

FIG. 4 illustrates a WoT clearing process, according to an embodiment. The process 308 includes receiving 402 the clear packet. The process 308 may further include clearing 406 the stored data (e.g., a future traffic indicator (counter value, etc.)) corresponding to the time slot indicated by LastIndex. In some embodiments, clearing the stored data includes setting 406 the corresponding traffic indicator at WoT[LastIndex] to zero. The process 308 may further include updating 408 the LastIndex. The LastIndex may be updated by incrementing the LastIndex to move forward in time, where move forward in time refers to the sequence in which time slots are processed within the WoT data structure. In some embodiments, the network element compares the updated or incremented LastIndex to the CurrIndex to determine 410 whether CurrIndex is greater than the updated LastIndex. Where the network element determines that the CurrIndex is not greater than the updated LastIndex, then the clear packet is dropped 412. Where the network element determines that the CurrIndex is greater than the updated LastIndex, then the clear packet is recirculated 414 and operations loop back to operation 402 to continue clearing old time slots. In some embodiments, the network element verifies or determines if the WoT current time (CurrIndex) has moved forward in time such that one or more time slots (LastIndex) have values that are obsolete and which may be required to be cleared (i.e., CurrIndex>LastIndex). If so, in some embodiments, the network element generates the clear packet if it can't clear such time slot while processing data packet. In some embodiments, creating a clear packet my include using a packet generator to generate the clear packet, or cloning-and-trimming a data packet, adding CurrIndex and LastIndex information and recirculating for the purposed of clearing old time slots.

In some embodiments, PCN proactively lowers the ECN marking threshold based on measurements from the WoT, which indicate a future congestion after a LookAheadTime period. For example, the network element may trigger an early congestion reaction at the host, using the value calculated for the future flow, which is read form the WoT. In some embodiments, the network element marks packets with ECN for L (adjustable) time slots where L may be set in response to a flow duration that might be indicated in the signaling packet (e.g., via the size indicator field 210). In some embodiments, L is determined by the average flow size, with a default value of 1. In some embodiment, the average flow size is indicated via the size indicator 210 in the signaling packet. This average flow size may further be used to determine the time period l, (the mitigation interval 712), which may further be used to determine the L number of time slots in future.

In some embodiments, background traffic that does not coordinate with the network using PCN, e.g. not providing signaling packets or TAG information, will be suppressed. In some embodiments, application traffic that provides TAG information benefits from this mechanism and will be processed without ECN marking until severe congestion is detected, as may be defined by the traditional ECN threshold.

One or more embodiments may apply to any appropriate IP switches. One or more embodiments may improve resource utilization which may benefit network service provider, including infrastructure providers, cloud providers, and enterprise network owners.

In some embodiments, a network element anticipates future network state by reading the WoT values at an index in the future based on a LookAhead index and predicts if in a window in the future, e.g., a future interval, there would be a network event (e.g., a congestion, increased traffic, etc.).

Some embodiments may provide for aggregating signals from packet sources and predicting or foreseeing congestion. Accordingly, a network element such as a switch may foresee congestion on egress ports before it happens. Some embodiments may provide for proactively adapting ECN marking to notify end hosts of congestion predicted in the future. Accordingly, sending rates may be adjusted proactively, thereby preventing congestion from happening. Some embodiments may prevent packet loss and reduce overall transmission time.

One or more embodiments may apply to RDMA. According to some embodiments, existing ECN-based congestion control mechanisms may be overwritten, providing faster convergence to an improved or maximum allowed rate.

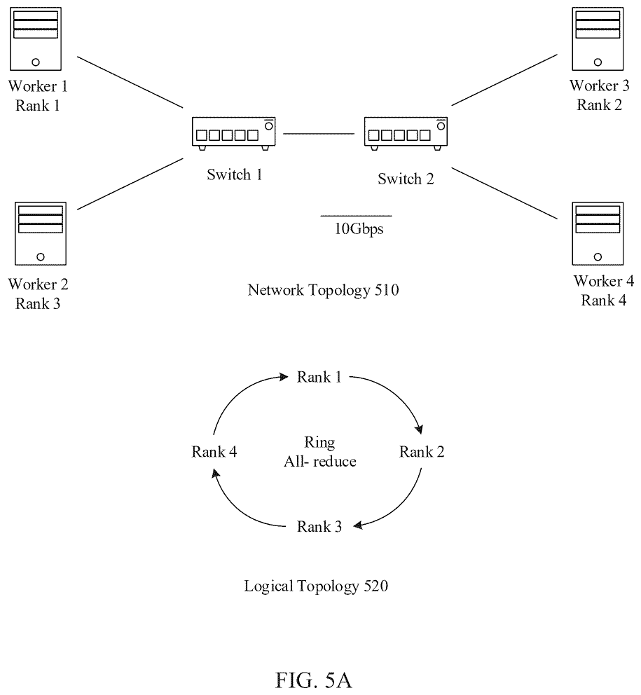

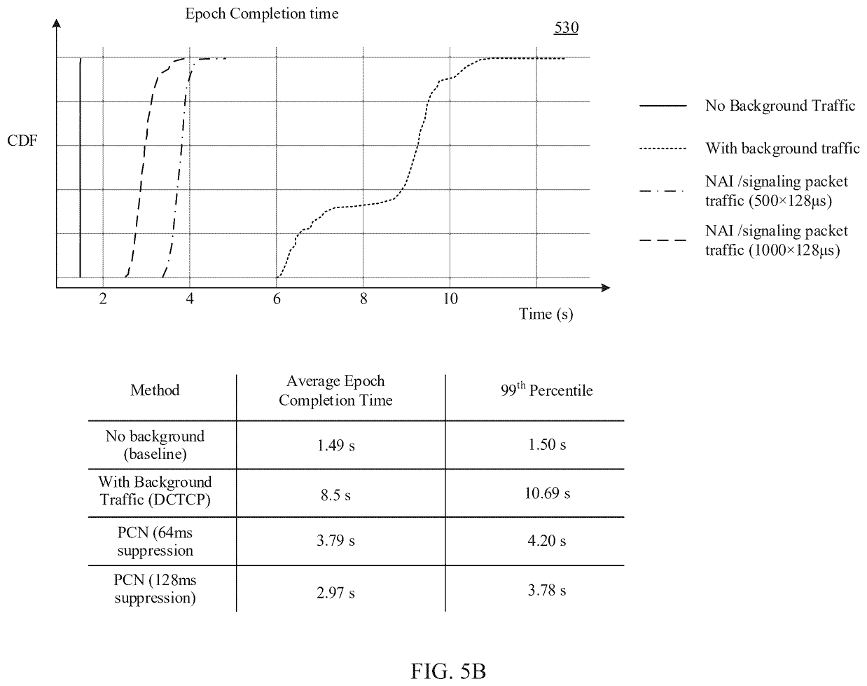

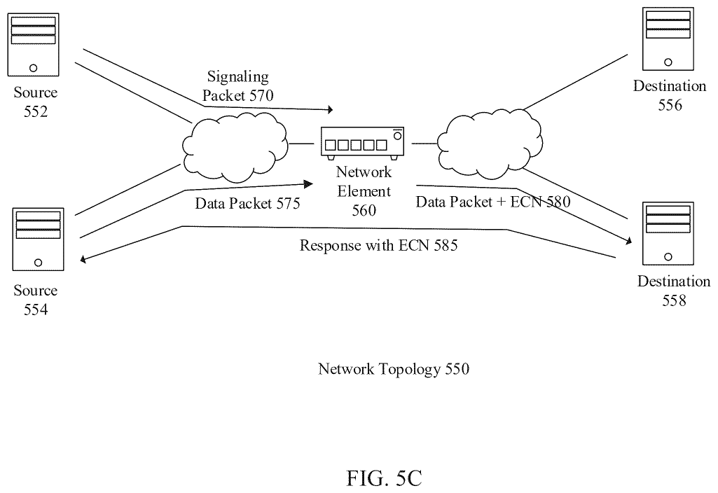

In an embodiment, a system was set up to evaluate PCN for improving distributed learning processes. FIG. 5A illustrates a system setup, according to an embodiment. The setup configuration indicated by network topology 510 and logical topology 520 included VGG19 Distributed Learning on PyTorch with Ring-All Reduce using Distributed Data Parallel (DDP) and NVIDIA Collective Communications Library (NCCL) frameworks. The system used four NVIDIA TU102 GPUs and Tofino P4 Switches interconnected via 10 Gbps Links. To generate background traffic, Iperf was employed between all pairs of workers, with PCN activated specifically on the link between Switch 1 and Switch 2.

During the experiment, DML workers initiated the transmission of signaling packets on the host, with an average lead time of 8 milliseconds and a standard deviation of 0.29 milliseconds before the actual DML traffic. PCN, upon receiving and aggregating these tags, commenced enforcing ECN on background traffic approximately 1 millisecond before the anticipated arrival of DML traffic, contingent upon the prediction of congestion.

FIG. 5B illustrates results of the system setup of FIG. 5A, according to an embodiment. The results of the experiment were analyzed comparatively across different methods. Graph 530 depicts epoch completion times under different traffic scenarios. The x-axis represents time in seconds, indicating the duration of the experiment or training epochs. The y-axis represents the Cumulative Distribution Function (CDF), which shows the cumulative distribution of epoch completion times. The baseline method, without PCN, exhibited an average epoch completion time of 1.49 seconds, with a 99th percentile time of 1.50 seconds. When employing DCTCP with background traffic, the average epoch completion time increased to 8.5 seconds, with a 99th percentile time of 10.69 seconds due to the impact of background traffic.

In contrast, the implementation of PCN with a 64 ms suppression interval demonstrated a notable improvement, reducing the average epoch completion time to 3.79 seconds, with a corresponding 99th percentile time of 4.20 seconds. Further enhancement was observed with PCN utilizing a 128 ms suppression interval, resulting in an average epoch completion time of 2.97 seconds and a 99th percentile time of 3.78 seconds.

These findings underscore the efficacy of PCN in mitigating congestion and optimizing training epoch times within distributed learning environments. By proactively managing network traffic and preemptively addressing congestion scenarios, PCN contributes to the efficiency and performance of distributed learning systems.

FIG. 5C illustrates a network topology 550 according to an embodiment of the present disclosure. The network includes a network element 560 which receives packets from sources 552, 552 and forwards them toward destinations 556, 558. The network element can be a network switch, router, or other networking device as will be readily understood by a worker skilled in the art. The network element can be a wired, wireless or optical device. The network element can refer to the entire device, or a portion of such a device. The portion can be a logical portion of a larger overall network element, the portion being defined by an input port, output port, or combination thereof. The sources 552, 554 and destinations 556, 558 can be wired, wireless or optical devices which are communicatively coupled to one another. The sources, destinations, or both can generate data packets for example due to applications running thereon, and the data packets are communicated across the network via the at least the network element 560. The sources and destinations can be directly or indirectly communicatively coupled to the network element 560. There may be multiple such network elements (not shown) along communication paths between sources and destinations.

Also illustrated in FIG. 5C is a signaling packet 570 which is sent from the source 552 and received at the network element 560. The signaling packet is handled by the network element as described elsewhere herein. For example, the network element 560, in response to the signaling packet, may mark a subsequently received data packet 575 from another source with an ECN marking. This marked data packet 580 is sent to a destination 558 as indicated in the data packet 575, 580. The destination will subsequently communicate with the source 554 via a response (e.g. an acknowledgement packet) 585, where the response includes the ECN. The source 554 will then reduce its transmissions as a result of the ECN, as will be readily understood by a worker skilled in the art, thus mitigating packet arrivals at the network element 560.

According to another aspect, a method of managing traffic at a port of a network element is provided. The method includes receiving, by the network element from one or more sources, one or more signaling packets. Each signaling packet indicates a future timepoint at which data of a flow is to be transmitted to the network element, where the data will be passed through the port. The method includes updating a future traffic indicator corresponding to the future timepoint based on the one or more signaling packets. The method further includes determining, by the network element, based on the future traffic indicator that a network condition is expected to occur at the port at the future timepoint. The method further includes performing, by the network element, at a current timepoint before the future timepoint, one or more actions to mitigate the network condition. In some embodiments, the future timepoint is a future interval. In some embodiments, the current timepoint is a current interval.

In some embodiments, the method further includes receiving, by the network element from a first source, a data packet of a first flow at the current timepoint before the future timepoint. In some embodiments, the current timepoint is associated with the network condition in the future timepoint. For example, the current timepoint is associated with the future timepoint based on a LookAheadTime as described herein.

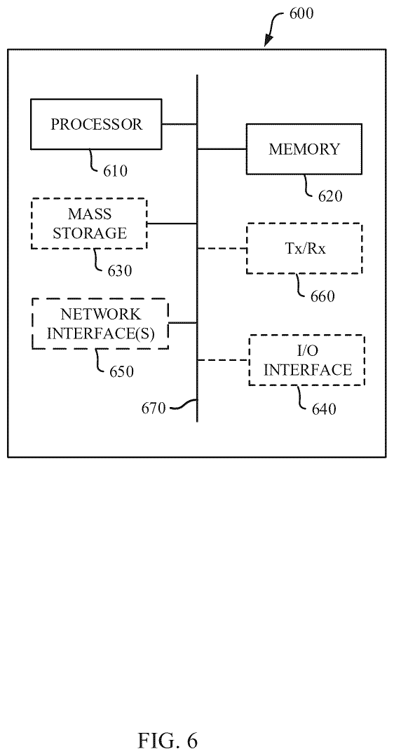

FIG. 6 is a schematic diagram of an electronic device 600 that may perform any or all of operations of the above methods and features explicitly or implicitly described herein, according to different embodiments of the present application. For example, a computer equipped with network function may be configured as electronic device 600. In some embodiments, electronic device 600 can be a device that connects to the network infrastructure over a radio interface, such as a mobile phone, smart phone or other such device that may be classified as user equipment (UE). In some aspects, the electronic device 600 may be a Machine Type Communications (MTC) device (also referred to as a machine-to-machine (m2m) device), or another such device that may be categorized as a UE despite not providing a direct service to a user. In some embodiments, electronic device 600 performs one or more operations in one or more embodiments described herein. In some embodiments, electronic device 100 is one or more of: a network element, a packet source (or a source of packet) according to one or more embodiments described herein. In some embodiments, electronic device 600 can act as a data processing unit, executing procedures and processing data as specified by the various methods. It may also function as a communication device, transmitting and receiving packets across different network layers and protocols. Furthermore, electronic device 600 can serve as a control unit, managing and orchestrating various network elements and resources.

Moreover, electronic device 600 can be one or more of the following: a network element, such as a router, switch, or gateway, facilitating the flow of data across the network; a packet source, generating and sending packets (including signaling packets, data packets) for transmission over the network; a packet destination, receiving and processing data packets from other network sources; a data storage device, storing data temporarily or permanently for processing or future use; a sensor or actuator, collecting data from the environment or performing actions based on received commands; a user interface device, such as a display or input device, providing interaction capabilities for end-users; a server, hosting applications, services, or databases accessible over the network; a client device, accessing services and resources provided by servers or other network elements; an intermediary device, performing tasks such as load balancing, data caching, or traffic management; a security device, implementing functions like encryption, decryption, authentication, or intrusion detection. These functionalities can be combined in various ways to create systems that perform a wide range of operations as described in the application.

As shown, the electronic device 600 may include a processor 610, such as a Central Processing Unit (CPU) or specialized processors such as a Graphics Processing Unit (GPU) or other such processor unit, memory 620, non-transitory mass storage 630, input-output interface 640, network interface 650, and a transceiver 660, all of which are communicatively coupled via bi-directional bus 670. According to certain embodiments, any or all of the depicted elements may be utilized, or only a subset of the elements. Further, electronic device 600 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 620 may include any type of non-transitory memory such as static random access memory (SRAM), dynamic random access memory (DRAM), synchronous DRAM (SDRAM), read-only memory (ROM), any combination of such, or the like. The mass storage element 630 may include any type of non-transitory storage device, such as a solid state drive, hard disk drive, a magnetic disk drive, an optical disk drive, USB drive, or any computer program product configured to store data and machine executable program code. According to certain embodiments, the memory 620 or mass storage 630 may have recorded thereon statements and instructions executable by the processor 610 for performing any of the aforementioned method operations described above.

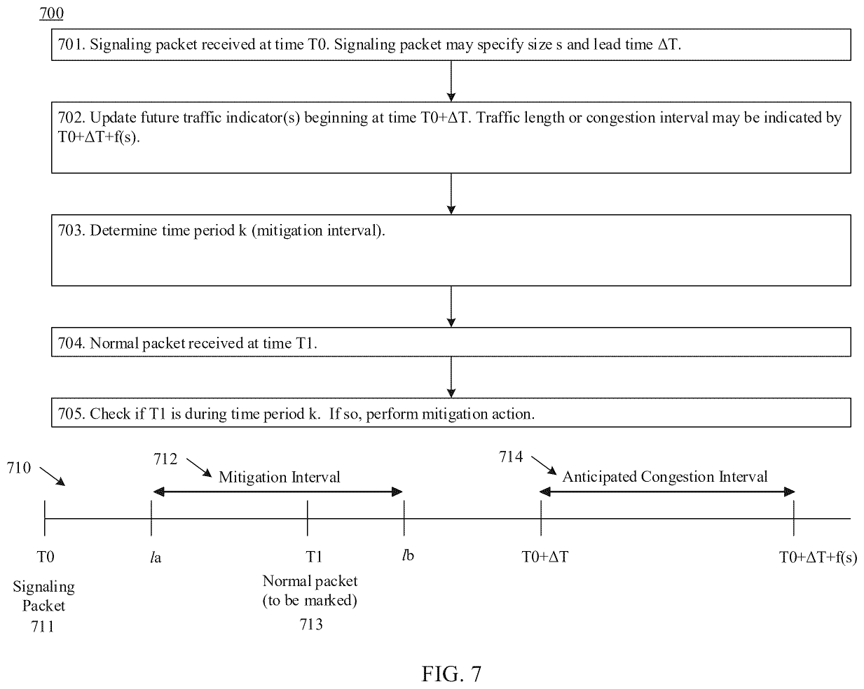

FIG. 7 illustrates a method of managing traffic at a network element, according to an embodiment. The method 700 corresponds to timeline 710 as illustrated. The method 700 includes a network element 600 receiving 701 a signaling packet 711 at time T0. T0 may refer to a current time which may be similar to a current interval or a CurrIndex of a WoT 102, for example. In some embodiments, the signaling packet may specific a size, s, and a lead time, ΔT.

In some embodiments, the method 700 further includes the network element updating 702 future traffic indicator(s) beginning at time T0+ΔT. The time T0+ΔT may indicate one or more future intervals for which one or more corresponding traffic indictors are updated. In some embodiments, the traffic length or the congestion interval may be indicated by T0+ΔT+f(s), where f(s) may be some increasing function of size, s, e.g., where s is a flow duration. For example, f(s) may equal s when s specifies the duration of the flow. Alternatively, f(s) may be a fixed value, e.g. equal to one time slot. This one or more future intervals are indicated as the anticipated congestion interval 714 in the timeline 710 beginning at T0+ΔT and ending at T0+ΔT+f(s).

In some embodiments, the method 700 further includes the network element determining 703 a time period l, which may be referred as a mitigation interval 712. Referring to the timeline 710, time period l includes all times, t, between la and lb such that if a mitigation action is taken at time t, a source will reduce its traffic flow during future times or interval falling in the anticipated congestion interval (T0+ΔT, T0+ΔT+f(s)).

In some embodiments method 700 further includes the network element receiving 704 a normal packet 713 at time T1. In some embodiments, method 700 further includes the network element checking 705 if T1 is during or within time period k. If T1 is within time period l, the network element performs one or more mitigation actions, e.g., marking the packet with ECN. If T1 is not within time period l, then the network element processes the packet as usual.

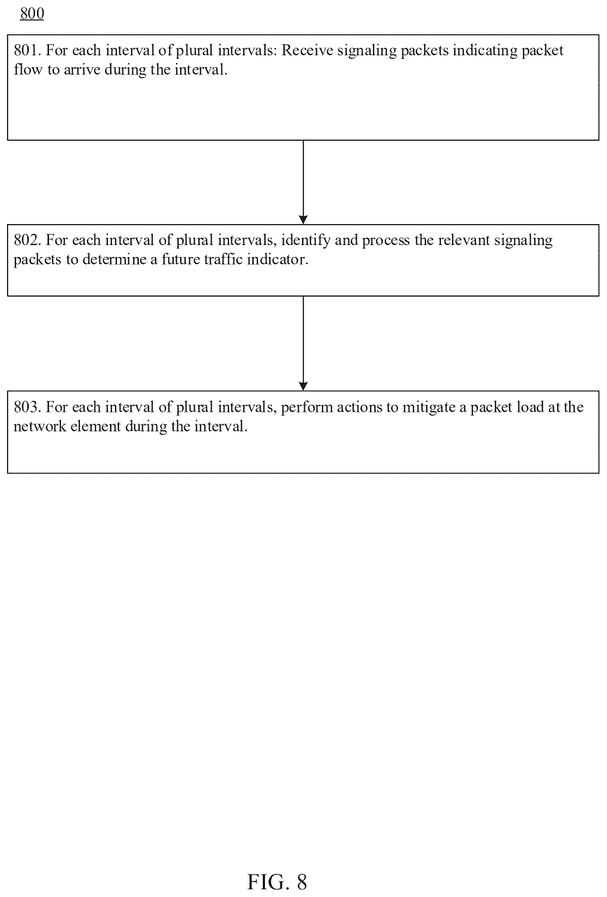

FIG. 8 illustrates another method for managing traffic at a network element, according to an embodiment. The method 800 may be performed by a network element 600. The method 800 includes, for each interval of a plurality of future time intervals, receiving 801, from one or more sources of packets, one or more signaling packets. Each signaling packet includes an indication that a packet flow of a given size(s) is to be provided to the network element from one of the sources after a given time, Δt, so that the packet flow is indicated to arrive during the interval. The method further includes, for each interval of a plurality of future time intervals, identifying and processing 802 the one or more signaling packets to determine a future traffic indicator which is generally increasing with a total number of the one or more signaling packets. Identifying a signaling packet can be performed by inspecting packet headers of all incoming packets, and determining that the signaling packet has a certain predetermined type of marker in its packet header. Once a packet is identified as a signaling packet, the packet is processed by performing logic operations based on packet contents which may be in the packet header, payload, or a combination thereof. The logic operations include parsing the packet contents to determine appropriate indications, and updating the future traffic indicator stored in memory, as described elsewhere herein. In some embodiments, the future traffic indicator is a number of flows, and the future traffic indicator increases with increasing number of signaling packets, where each signaling packet indicates a corresponding flow. In some embodiments, the given size of a packet flow spans one or more time slots. The method further includes, for each interval of a plurality of future time intervals, with enough time for the network traffic to react before the beginning of the interval, performing 803 one or more actions over a given time period (l), to mitigate a packet load at the network element during the interval.

In some embodiments, the one or more actions include ECN marking of packets during an advanced time interval (which may be the given time period, l) prior to the beginning of the interval. The ECN marking may be performed to a degree that is generally increasing with the future traffic indicator. In some embodiments, the ECN marking is performed to a degree that is greater than a baseline degree that is implemented for a baseline interval. The baseline interval is an interval other than the plurality of future time intervals and for which no signaling packets, indicating that packet flow to the network element, have been received. For example, the baseline degree can be that ECN marking is not performed at all. Alternatively, the baseline degree can be that ECN marking is performed randomly with some small nominal probability. The baseline interval can be an interval during which congestion is not expected, or corresponding to times for which no signaling packet has indicated that a packet flow is to arrive. In some embodiments, the one or more actions include configuring, based on the future traffic indicator, ECN marking rules (e.g. lowering ECN marking threshold) to be applied by the network element during an advanced time interval prior to the beginning of the interval. In some embodiments, the network element is a portion of a switch or router corresponding to a particular port or group of ports of the switch or router. In some embodiments, the signaling packets are dedicated to carrying the indications.

In some embodiments, the method further includes forwarding the packets toward a further network element. In some embodiments, at least one of the signaling packets includes a field 214 specifying the interval or specifying a greater time interval which spans multiple successive ones of the plurality of future time intervals, including the interval. In some embodiments, the field at least in part provides the indications. In some embodiments, at least one of the signaling packets includes a field 210 specifying a volume, rate or other indication of traffic level, and the future traffic indicator reflects a sum, over the one or more signaling packets, of the specified volumes, rates, or other indications of traffic level indicated therein. In some embodiments, the future traffic indicator is or comprises a count of the one or more signaling packets.

In some embodiments, the one or more actions are configured to generally increase in intensity with the future traffic indicator to facilitate the mitigation by affecting sources of the network traffic. In some embodiments, the one or more actions include mitigating one or more packet flows based at least in part on packet flow priority. In some embodiments, the one or more actions are performed during an advanced time interval that is configured to result in mitigating of the packet load at the network element during the time interval.

In some embodiments, the method further includes by at least one source of the one or more sources of packets, in advance of an anticipated increase in packet flow from the at least one source toward the network element, generating and transmitting at least one of the one or more signaling packets.

Embodiments of the present application can be implemented using electronics hardware, software, or a combination thereof. In some embodiments, the application is implemented by one or multiple computer processors executing program instructions stored in memory. In some embodiments, the application is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include a number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. The specification and drawings are, accordingly, to be regarded simply as an illustration of the application as defined by the appended claims, and are contemplated to cover any and all modifications, variations, combinations or equivalents that fall within the scope of the present application.

What is claimed is:

1. A method for managing network traffic passing through a network element, comprising, by the network element:
receiving one or more signaling packets, each signaling packet comprising an indication that a packet flow of a given size is to be provided to the network element after a given time ΔT;
processing the one or more signaling packets to determine a future traffic indicator which is generally increasing with a total number of the one or more signaling packets; and
prior to a beginning of the interval, performing one or more actions over a given time period (l), to mitigate a packet load at the network element during the interval.

2. The method of claim 1, wherein the one or more actions include Explicit Congestion Notification (ECN) marking of packets during the given time period (l), prior to the beginning of the interval, the ECN marking being performed to a degree that is generally increasing with the future traffic indicator.

3. The method of claim 2, wherein the ECN marking is performed to a degree that is greater than a baseline degree that is implemented for a baseline interval, the baseline interval being other than the plurality of future time intervals and for which no signaling packets, indicating that packet flow to the network element, have been received.

4. The method of claim 1, wherein the one or more actions include configuring, based on the future traffic indicator, ECN marking rules to be applied by the network element during an advanced time interval prior to the beginning of the interval.

5. The method of claim 1, wherein the network element is a portion of a switch or router corresponding to a particular port or group of ports of the switch or router.

6. The method of claim 1, wherein the packets are dedicated to carrying the indications.

7. The method of claim 1, further comprising forwarding the packets toward a further network element.

8. The method of claim 1, wherein at least one of the packets comprises a field specifying the interval or specifying a greater time interval which spans multiple successive ones of the plurality of future time intervals, including the interval, the field at least in part providing the indications.

9. The method of claim 1, wherein at least one of the packets comprises a field specifying an indication of traffic level, and the future traffic indicator reflects a sum, over the one or more signaling packets, of the specified indication of traffic level.

10. The method of claim 1, wherein the future traffic indicator is or comprises a count of the one or more signaling packets.

11. The method of claim 1, wherein the one or more actions are configured to generally increase in intensity with the future traffic indicator to facilitate the mitigation by affecting sources of the network traffic, such that the sources of the network traffic reduce traffic output by a degree which increases with said intensity.

12. The method of claim 1, wherein the one or more actions include mitigating one or more packet flows based at least in part on packet flow priority.

13. The method of claim 1, wherein the one or more actions are performed during an advanced time interval that is configured to result in mitigating of the packet load at the network element during the time interval.

14. The method of claim 1, further comprising, by at least one source of the one or more sources of packets:
in advance of an anticipated increase in packet flow from the source toward the network element, generating and transmitting at least one of the one or more signaling packets.

15. A network element comprising processing electronics and a communication interface and configured, in support of managing network traffic passing through the network element, to:
for each interval of a plurality of future time intervals:
receive one or more signaling packets, each signaling packet comprising an indication that a packet flow of a given size is to be provided to the network element after a given time ΔT;
process the one or more signaling packets to determine a future traffic indicator which is generally increasing with a total number of the one or more signaling packets; and
prior to a beginning of the interval, perform one or more actions over a given time period (l), to mitigate a packet load at the network element during the interval.

16. The network element of claim 15, wherein the one or more actions include Explicit Congestion Notification (ECN) marking of packets during the given time period (l), prior to the beginning of the interval, the ECN marking being performed to a degree that is generally increasing with the future traffic indicator.

17. The network element of claim 15, wherein the ECN marking is performed to a degree that is greater than a baseline degree that is implemented for a baseline interval, the baseline interval being other than the plurality of future time intervals and for which no signaling packets, indicating that packet flow to the network element, have been received.

18. The network element of claim 15, wherein the one or more actions include configuring, based on the future traffic indicator, ECN marking rules to be applied by the network element during an advanced time interval prior to the beginning of the interval.

19. The network element of claim 15, wherein at least one of the packets comprises a field specifying the interval or specifying a greater time interval which spans multiple successive ones of the plurality of future time intervals, including the interval, the field at least in part providing the indications.

20. The network element of claim 15, wherein at least one of the packets comprises a field specifying an indication of traffic level, and the future traffic indicator reflects a sum, over the one or more signaling packets, of the specified indication of traffic level.

21. A computer program product comprising a non-transitory computer readable medium, having stored thereon statements and instructions which, when executed by a computer processor of a network element, cause the network element to implement a method for managing network traffic passing through a network element, the method comprising:
for each interval of a plurality of future time intervals:
processing the one or more signaling packets to determine a future traffic indicator which is generally increasing with a total number of the one or more signaling packets; and
prior to a beginning of the interval, performing one or more actions over a given time period (l), to mitigate a packet load at the network element during the interval.
